(19) United States
(12) Patent Application Publication
(10) Pub. No.: US 2003/0209999 A1
(43) Pub. Date: Nov. 13, 2003

(54) Wireless remote control systems for dimming electronic ballasts

(75) Inventors: Shu Yuen Ron Hui, Kowloon (HK); Shu-Hung Chung, Kowloon (HK)

Correspondence Address: MERCHANT & GOULD PC, P.O. BOX 2903, MINNEAPOLIS, MN, 55402-0903, US

(73) Assignee: E.Energy Technology Limited, Kowloon (HK)

(21) Appl. No.: 10/143,524

(22) Filed: May 9, 2002

(51) Int. Cl. G05F 1/00

(52) U.S. Cl. 315/294; 315/318; 315/312; 315/324

(57) ABSTRACT

The present invention provides a low-cost and simple system for the remote control of dimmable electronic ballasts. The system includes a transmitter module for transmitting dimming data to a ballast, and a receiver module for receiving the dimming data and outputting a dimming signal in response thereto. Optionally the transmitter module may also control ON/OFF operation and will also include address data identifying the ballast to be controlled.

### FIELD OF THE INVENTION

The present invention relates to the designs and structures of wireless remote control lighting systems that sa compatible with standard 4-wire dimming electronic ballasts. The proposed system is simple, addressable and is capable of low-cost application.

### BACKGROUND OF THE INVENTION

Commercially available dimming electronic ballasts for fluorescent lamps ate 4-wire system as shown in FIG. 1. In addition to the two AC wire for “live (L)” and “neutral (N)”, two DC wires (DC1 and DC2) are provided for providing the dimming signal of a DC voltage (Vdim) typically between 1V to 10V. Usually a wall-mounted dimmer circuit is required (so that it can easily be operated by a person in the room) and this requirement means that long DC wires have to be installed between the wall-mounted dimmer unit and all the dimming electronic ballasts. This need for re-wiring of the building because of the extra DC wires and the provision of she dimming control circuit increases the cost and complexity of such an installation, especially if dimming control is to bc “rtrofittcd” to existing fluorescent lamps. This is a major factor that hinders the wide spread applications of dimming electronic ballast. In order to overcome these problems, various attempts using wireless control have been made.

### PRIOR ART

In U.S. Pat. No. 6,252,358 Xydis and Angott propose a wireless lighting control syst=using non-dimming electronic ballasts. Their system consists of a remote control unit, a receiver unit and a light control unit. The control unit has a single button for producing a single signal. The light control unit has many ON/OFF outputs, and each of them is hard-wired to the ON/OFF control of the respective non-dimming electronic ballast. The light controller is responsive to the remote control for sequentially and in numerical order changing the supply of electrical power source to the lighting devices. This system does not control the light intensity of all of the lighting devices uniformly.

In U.S. Pat. No. 5,506,715 Zhu describes an infra-red remote system for dimming fluorescent lamp tubes. However, all infra-red systems have the limitation that infra-red systems are directional and are of high cost because of the need for light filtration. Due to the fact that the infrared transmitter must point directly and without obstacles at the infra-red receiver, it is not suitable for situation when lighting control electronics must bc hidden, for example behind a ceiling or decoration.

In U.S. Pat. No. 6,340,864 Wacyk proposes a rather complex and sophisticated wireless remote sensing system for lighting control. In this system, CMOS pixel array imaging technology is Incorporated Into an opto-sensing system for automatically adjusting the lighting intensity in a certain environment. The said sensor collects analog data in each pixel of the array, which is converted into digital data by a A/D converter and then processed by a digital signal processor (DSP) to extract information such as objects in motion and light levels from various sources so as to provide appropriate Control signal to the lighting system. Due to the complexity of the system and the large amount of data involved, these data have to be compressed for transmission. Typical data transmission rate is in the order of 10 Kilo bits/second. Thus, fast and expensive DSP is needed in the transmitter for such implementation. For the same reason, data decompression is needed in the expensive DSP used in the receiving end. As an auto-sensing system, Wacyk's invention is for a system that maintains constant lighting intensity in the illuminated environment.

Hakkarainen et al in U.S. Pat. No. 5,637,964 propose another sophisticated infra-red remote control lighting system for specially designed ‘3-wire’ electronic ballasts ether than a standard wire electronic ballasts. The ballast control unit consists of a power supply, an IR signal receiver, an EEPROM, a microprocessor and semiconductor dimmer circuit (such as a triac dimmer)

### SUMMARY OF THE ITION

According to the present invention there is provided a wireless radio-frequency remote control system for a dimmable electronic ballast operated fluorescent lamp, said control system comprising a transmitter module and a receiver module, wherein transmitter module comprises means for transmitting address data identifying a receiver module and lamp dimming data, and said receiver module is provided with mean for receiving transmitted data from said transmitter module, means for comparing received address data with a unique identification address stored in said receiver module, and means for generating in response to said lamp dimming data a DC dimming signal to be input to said ballast

In a preferred embodiment of the invention, in addition to dimming data, the transmitter module comprises means for transmitting a power on/off signal to said receiver module, and said receiver module is provided with means for switching on/off the power to said ballast. For example, this switching means may comprise a relay provided in the AC power line to said ballast.

Preferably, if the system is provided with such on/off control, than the receiver module may comprises means for initiating a warm-start ignition process when said receiver module receives a signal to switch a lamp on. In this embodiment upon receiving a signal to switch a lamp on, the receiver module preferably first generates a low dimming voltage that is insufficient to turn the lamp on but which will warm up the lamp filaments, and then subsequently generates an ignition voltage sufficient to turn the lamp on. After generating the ignition voltage the voltage generated by the receiver module may then gradually move to a desired dimming voltage.

A receiver module may provide remote control of a Ale ballast and lamp, or alternatively may provides the DC ding signal to a plurality of ballasts such that a number of lamps may be controlled together as a group.

Another possibility is that a plurality of receiver modules may be provided, each with a unique identification address, and a single transmitter module may provide dimming data to an individual receiver module by setting the appropriate identification address as the address data.

Preferably, in order to take into account the fiat that a person's pupils will dilate as a lamp is dimmed, the receiver module implements a square-law mapping to convert received dimming data to the DC dimming signal.

The transmitter module comprises a battery-powered remote control unit, and wherein said remote control unit goes into a sleep mode when not in use, and preferably comprises means for inputting dimming commands, means for centering an identification address, microprocessor means for generating a datastream to be transmitted comprising the identification address and the dimming data, and means for transmitting the datastream. The transmitter module may further comprises means for entering an ONOFF command, and may include memory means for storing a current dimming status of a lamp.

### BRIEF DESCRIPTION OF THE DRAWINGS

Some embodiments of the invention will now be described by way of example and with reference to the accompanying drawings, in which:—

FIG. 1 is a schematic diagram of a conventional 4-wire dimmable electronic ballast fluorescent lamp system,

FIGS. 2(a) and (b) are schematic diagrams of first and second embodiments of wireless remote control systems according to the present invention,

FIGS. 3(a) and (b) illustrate exemplary data structures and transmission formats for use in embodiments of the present invention,

FIGS. 4(a) and (b) are schematic diagrams of receiver modules according to embodiments of the invention,

FIG. 5 is a schematic diagram of a wireless remote-control transmitter according to an embodiment of the invention,

FIG. 6 illustrates a typical dimming control signal in accordance with an embodiment of the present invention and providing a warm-start ignition process, and

FIG. 7 is a plot showing the square-law mapping between actual dimming voltage and digitized dimming value used to compensate for pupil dilation.

### DETAILED DESCRIPTION OF PREFERRED EMBODIMENTS

In the present invention, a low-cost radio frequency (RF) wireless dimming control system is provided that is compatible with standard 4-wire electronic dimmable ballasts. The proposed system is low-cost, simple and addressable. The proposed system can be used for single or multiple electronic ballasts systems.

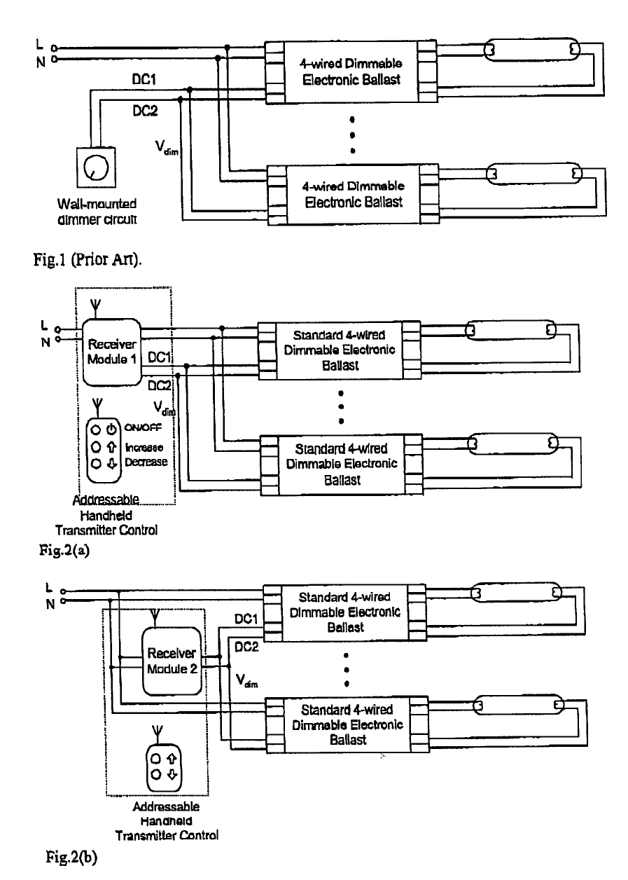

First and second embodiments or the invention are shown In FIG. 2a (which provides both ON/OFF control plus dimming control) and FIG. 2b (which provides dimming control only). These embodiments of the invention comprise a transmitter control module and a receiver module, The transmitter module can bc a hand-held remote control unit as shown in FIG. 2a and FIG. 2b or a computer-connected transmission board. Each of the transmitter and receiver modules has an N-bit address set for its identification. Therefore, there could be 2^{N} different addresses in this system. The addresses of the receiver and transmitter modules in each zone should be identical. If the remote control lighting systems are installed in different zones, the address of the transmitter and receiver modules in each zone should be set at a value that is different from the address values of its neighboring zones in order to avoid interference.

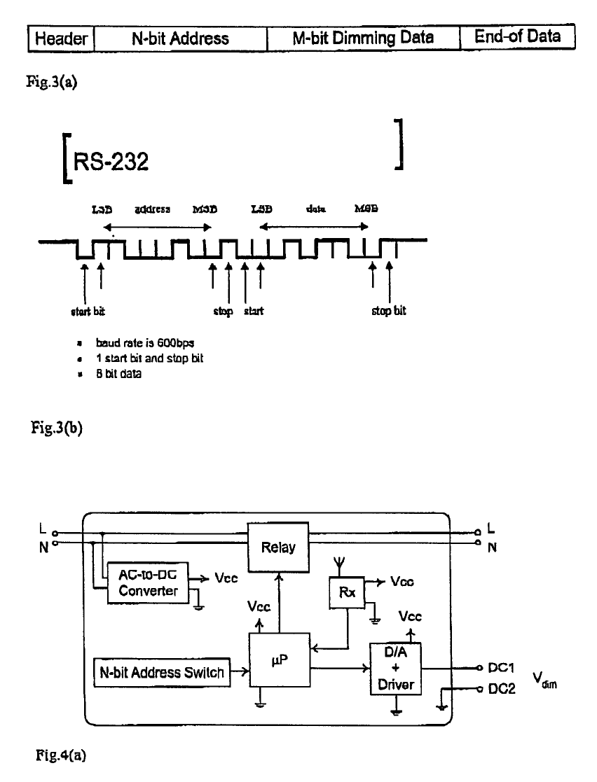

The function of the transmitter module is to transmit (i) an N-bit address to alert the receiver module with the same address and then (ii) an M-bit digital data representing the dimming level. A maximum of 2^{M} dimming levels are thus available. Information required for the transmission is shown in FIG. 3a. A typical example of the data format is shown in FIG. 3b and it will be noted that the data format is very simple, and therefore very low-cost microprocessors can be used in the transmitter module and receiver module. The transmission rate can be very low, typically 0.6 Kilo bits per second (i.e. two orders of magnitude loss than that of Wacyk's proposal). Thus, low-cost RF transmitter and receiver circuits can be used.

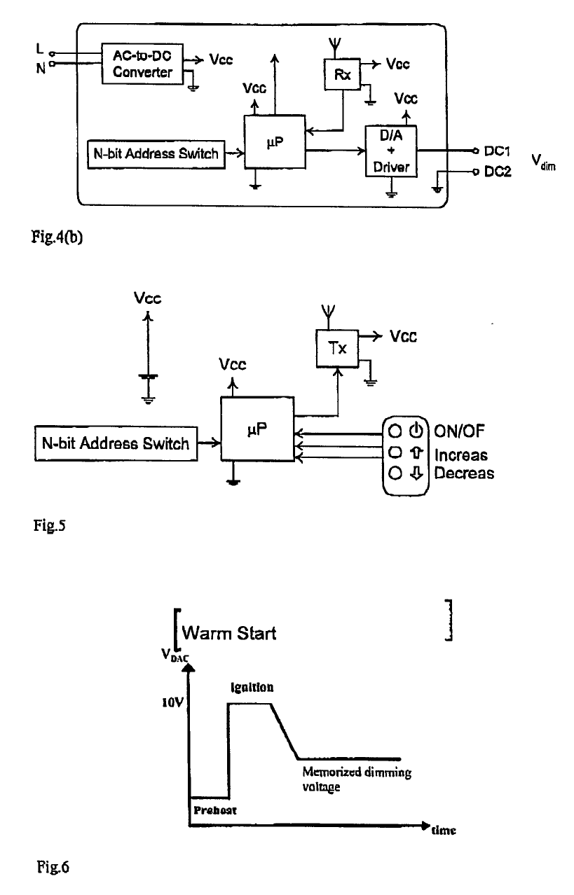

The receiver module can take two forms as shown in FIG. 2a and FIG. 2b. The schematic of receiver module 1 in FIG. 2a is shown In FIG. 4a. It consists of an electrically isolated AC-DC power supply, RF receiver circuit (Rx) including an antenna, a microprocessor (μP), a N-bit switch (such as a DIP switch) representing the identification address, and an optional buffered D/A converter circuit that provides the DC dimming signal Vdim (within 1V to 10V) for lines DC1 and DC2 of the standard dimming electronic ballasts. In the first form of the receiver module, the receiver module also has a relay as an electronically controlled mechanical switch for the AC power to the electronic ballasts (FIG. 4a) to provide a power ON/OFF function. The identification address of the receiver module can be set manually in the N-bit mechanical Etch The power supply provides DC power for the microprocessor and the RF receiver circuit. The RF receiver circuit receives the digital data from the transmitter module. The microprocessor checks the address code first, and if the address code is identical to the identification address of the receiver modules, the microprocessor will accept the transmitted data The dimming data represents an absolute dimming level. Once accepted, the dimming data will be converted into an analog DC dimming voltage signal (Vdim) by the D/A converter for the DC lines DC1 and DC2 of the dimming electronic ballasts. The D/A conversion of this dimming signal (Vdim) can be derived from an A/D converter circuit However, for low-cost microprocessors without an inbuilt DWA converter, a low-cost solution to this D/A conversion is to use the microprocessor to generate a variable duty-cycle PWM signal and then filter this PWM signal with a resistive-capacitor (RC) filter. The control of the duty-cycle of the PWM signal determines the DC dimming signal voltage level. The larger the duty-cycle, the higher the DC voltage in the output of the RC filter.

The block diagram of the receiver module in FIG. 2) is shown in FIG. 4(b). This receiver module is similar to that in FIG. 2(a) and FIG. 4(a), except that it does not have a relay to control tie AC power of the electronic ballasts. This means that the remote control system described in FIG. 2(b) provides dimming control only for the electronic ballasts and not the ON/OFF control (The ON/OFF control can be achieved by turning off the AC power in this case).

FIG. 5 shows the schematic diagram of the transmitter module if a battery-powered hand-held remote control unit is preferred. This consists of battery source (typically one or two AAA type batteries), a RF transmitter circuit (TX) including an antenna, a microprocessor (μP), a N-bit switch for setting the identification address and a control panel consisting of at least 2 control buttons.

For the system including the ON/OFF control, the remote control transmitter module should have at least 3 control buttons. One button is for ‘ON/OFF’ control, the second one is for ‘increase’ of dimming level and the third one is for ‘decrease’ of the dimming level. The microprocessor is normally in ‘sleep’ mode and consumes minimum power if any of the control buttons is not pressed for a while. This is an energy saving management approach for a battery-powered hand-held remote control transmitter. If any of the buttons is activated, the microprocessor will jump to the ‘active’ mode. In the active mode, the microprocessor will read the N-bit address data. It will also react according to which button is pressed, is If the ON/OFF button is activated, it will transmit the N-bit address data, an M-bit dimming data and an ON/OFF signal (for the relay) sequentially as shown in FIG. 3 via the RF transmitter circuit. The M-bit dimming data is the original one stored in the memory of the microprocessor if neither of the ‘increase’ nor ‘decrease’ button is pressed. The ONIOFF signal will trigger the relay to turn on or off. If the relay is turned off initially, it will be turned on after the receiving module receives the ON/OFF signal, and vice versa. If only the ON/OFF button is pressed to turn on the lighting system, the lighting control includes a warm-start process to fully turn on the lighting devices such as discharge lamps (e.g. fluorescent lamps) before the lap is dimmed to the memorized dimming level. This warm-start process is illustrated in FIG 6. The microprocessor based receiver module will initially generate a low dimming voltage (typically 1V-2V) for the DC lines DCI and DC2 for a short period (typically 0.5 s to 1 s). This dimming voltage will not cause the electronic ballast to generate a high voltage to ignite the discharge lamp. Instead, it will cause a current to warm up the filaments of the discharge lamps for the next ignition step. After the warm-up period, the receiver module generates a full dimming voltage signal of 10V to fully turn on the fluorescent lamps. Then the dimming level will gradually move back to its previous stored value. The warm-start process described here is a technique for ensuring long lifetime of the discharge lamps.

If either the ‘increase’ or ‘decrease’ button is pressed, the dimming data will be ‘increased’ or ‘decreased’, respectively within the range of the 2^{M} dimming levels. Both the address data and the latest dimming data will be transmitted as long as either of the continuously the latest dimming level for the dimming electronic ballast.

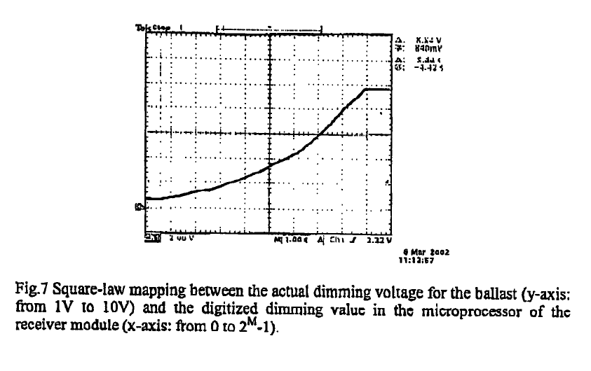

It is a known phenomenon that the human eyes compensate for diminishing light by dilating the pupils to let more light in, and the actual amount of light and the perceived amount of light obeys a square-law. This feature is implemented in the present invention by using a square-law type distribution of the DC dimming voltage signal (for DC1 and DC2 of the electronic ballast) over the full range of the digitized dimming range (2^{M} digital values from 0 to 2^{M}−1) in the microprocessor. This square-type mapping is illustrated in FIG. 7.

The receiver module of the proposed system provides the dc dimming voltage for the electronic ballasts and can be installed close to the electronic ballast. Consequently, the proposed wireless remote control system eliminates the need for installing long dc wires and thus the need for wiring the building when commercial 4-wire dimming electronic ballasts ale installed. Furthermore the system can provide warn-start process for discharge lamps and memorize me dimming level set by the user even after the lighting system is turned off.

1. A wireless radio-frequency remote control system for a dimmable electronic ballast operated fluorescent lamp, said control system comprising a transmitter module and a receiver module, wherein transmitter module comprises mean for transmitting address data identifying a receiver module and lamp dimming data, and said receiver module is provided with means for receiving transmitted data from said transmitter module, means for comparing received address data with a unique identification address stored in said receiver module, and means for generating in response to said lamp dimming data a PC dimming signal to be input to said ballast.

2. A remote control system as claimed in claim 1 wherein said transmitter module comprises means for transmitting a power on/off signal to said receiver module, and said receiver modulo is provided with means for switching on/off the power to said ballast.

3. A remote control system as claimed in claim 2 wherein said switching means comprises a relay provided in the AC power line to said ballast.

4. A remote control system as claimed in claim 2 wherein said receiver module comprises means for initiating a warm-start ignition process when said receiver module receives a signal to switch a lamp on.

5. A remote control system as claimed In claim 4 wherein upon receiving a signal to switch a lamp on, said receiver module first generates a low dimming voltage that is insufficient turn the lamp on but which will warm up the lamp filaments, and than subsequently generates an ignition voltage sufficient to turn the lamp on.

6. A remote control system as claimed in claim 5 wherein after generating the ignition voltage the voltage generated by the receiver module gradually moves to a desired dimming voltage.

7. A remote control system as claimed in claim 1 wherein said receiver module provides said DC dimming signal to a plurality of ballasts.

8. A remote control system as claimed in claim 1 wherein a plurality of receiver modules arm provided, each with a unique identification address, and wherein a single transmitter module may provide dimming data to an individual receiver module by setting the appropriate identification address as the address data.

9. A remote control system as claimed in claim 1 wherein said receiver module implements a square-law mapping to convert received dimming data to said DC dimming signal.

10. A remote control system as claimed in claim 1 wherein said transmitter module comprises a battery-powered remote control unit, and wherein said remote control unit goes into a sleep mode when not in use.

11. A remote control system as claimed in claim 1 wherein said transmitter module comprises means for inputting dimming commands, means for entering an identification address, microprocessor means for generating a datastream to be transmitted comprising said identification adds and said dimming data, and means for transmitting said datastream.

12. A remote control system as claimed in claim 11 wherein said transmitter module farther comprises means for entering an ON/OFF command.

13. A remote control system as claimed in claim 11 wherein said microprocessor means includes memory means for storing a current dimming status of a lamp.
